(19) United States
(12) Patent Application Publication
(10) Pub. No.: US 2013/0031749 A1
(43) Pub. Date: Feb. 7, 2013

(54) LOCATING MODULE STRUCTURE FOR PIVOT PIN

(71) Applicants: AN SZU HSU, NEW TAIPEI CITY (TW); CHIEN CHENG MAI, NEW TAIPEI CITY (TW); WAY HAN DAI, NEW TAIPEI CITY (TW); CHIEN NAN TSAI, NEW TAIPEI CITY (TW)

(72) Inventors: AN SZU HSU, NEW TAIPEI CITY (TW); CHIEN CHENG MAI, NEW TAIPEI CITY (TW); WAY HAN DAI, NEW TAIPEI CITY (TW); CHIEN NAN TSAI, NEW TAIPEI CITY (TW)

(73) Assignee: FIRST DOME CORPORATION, NEW TAIPEI CITY (TW)

(21) Appl. No.: 13/587,001

(22) Filed: Aug. 16, 2012

Related U.S. Application Data
(62) Division of application No. 13/196,063, filed on Aug. 2, 2011.

(51) Int. Cl. E05D 5/12

(52) U.S. Cl. 16/381; 16/380

(57) ABSTRACT

A locating module structure for pivot pin is disclosed. The pivot pin has a deployed section for assembling with at least one locating module. The locating module is formed with a geometrical configuration. The locating module has a continuous section and an opening. The continuous section interferes with the pivot pin. When the pivot pin is rotated, the locating module applies a frictional force to the pivot pin to provide a locating effect. In comparison with the conventional locating assembly, the locating module has simplified structure and is easier to adjust in interference extent. Moreover, the locating module solves the problem existing in the conventional locating assembly that the conventional locating assembly is easy to deform and wear.

### RELATED APPLICATIONS

This application is a Divisional patent application of co-pending application Ser. No. 13/196,063, filed on 2 Aug. 2011, now pending. The entire disclosure of the prior application, Ser. No. 13/196,063, from which an oath or declaration is supplied, is considered a part of the disclosure of the accompanying Divisional application and is hereby incorporated by reference.

### BACKGROUND OF THE INVENTION

1. Field of the Invention

The present invention relates generally to a (sealed-type) pivot pin structure applied to an electronic device, and more particularly to a pivot pin assembled with a locating module. The pivot pin has simplified structure and is easier to assemble and adjust in interference extent. Moreover, the locating module solves the problem existing in the conventional locating assembly that the conventional locating assembly is easy to wear and deform under stress.

2. Description of the Related Art

Various pivot pin structures (or rotary shaft structures) have been developed and applied to electronic devices such as mobile phones, laptops, electronic books and digital image sensors. By means of the pivot pin structures, the covers or display screens of the electronic devices can be pivotally rotated and opened/closed.

Basically, the conventional locating assembly includes multiple disc-shaped gaskets. The gaskets are assembled with the pivot pin in a stacked state. The gaskets are directed in the same direction or in reverse directions. The gaskets are tightened by means of a nut. When the cover or display screen is rotated and opened/closed around the pivot pin, the gaskets provide an elastic holding effect or apply a factional resistance to the pivot pin for locating the cover or display screen.

The elastic holding effect or frictional resistance is adjustable by means of operating the nut to adjust the tightness of the gaskets, in the case that the gaskets are under-tightened, the pivot pin (or the cover or display screen) can be hardly truly located. On the contrary, in the case that the gaskets are over-tightened, the gaskets are often deformed under stress. Under such circumstance, the components of the pivot pin are very likely to wear after a period of use. As a result, the pivot pin will become loosened to cause unstable operation thereof.

Therefore, it is quite troublesome and difficult for an assembler to operate the nut to adjust the tightness of the gaskets for achieving optimal elastic holding effect or fractional resistance. In practice, the gaskets are subject to deformation and damage. This will lead to non-uniform elastic holding effect or frictional resistance in operation of the pivot pin. As a result, the ratio of defective products is quite high and the manufacturing cost is increased.

It is therefore tried by the applicant to provide an improved locating module structure for pivot pin, which has simplified structure and is easier to assemble and adjust in elastic holding effect or frictional resistance. Accordingly, the locating module structure can solve the problem existing in the conventional locating assembly that the conventional locating assembly is easy to wear and deform under stress.

In comparison with the conventional locating assembly, the locating module has simplified structure and is easier to adjust in interference extent. Moreover, the locating module solves the problem existing in the conventional locating assembly that the conventional locating assembly is easy to deform and wear. An assembler can increase or decrease the number of the locating modules according to the actually needed frictional resistance. Therefore, the locating module structure can provide uniform elastic holding effect or frictional resistance in operation of the pivot pin. Moreover, the locating module is such configured that the locating module has larger allowable deformation and higher yield point. Accordingly, the locating module is applicable to different pivot pins with different specifications. Therefore, the application range of the locating module is widened.

### SUMMARY OF THE INVENTION

It is therefore a primary object of the present invention to provide a locating module structure for pivot pin. The locating module solves the problem existing in the conventional locating assembly that the conventional locating assembly has complicated structure and is inconvenient to adjust in interference extent. The pivot pin is mounted between a main body and a movable body (such as a cover or a display screen) of an electronic device. The pivot pin has a deployed section for assembling with at least one locating module. The locating module is formed with a geometrical configuration. The locating module has a continuous section and an opening. The continuous section interferes with the pivot pin. When the pivot pin is rotated, the locating module applies a fractional force to the pivot pin to provide a locating effect. The locating module solves the problem existing in the conventional locating assembly that the conventional locating assembly is easy to deform and wear.

To achieve the above and other objects, the locating module structure for the pivot pin of the present invention includes at least one locating module. The pivot pin includes a first pin section and a second pin section, which can be fitted on the first pin section.

The pivot pin has a deployed section positioned on the first pin section. The second pin section has a chamber corresponding to the deployed section of the first pin section. The chamber of the second pin section is at least fitted on the deployed section. The deployed section has a restriction section for holding the locating module. The restriction section has the form of an insertion split extending along the axis of the pivot pin.

The locating module has a head end. The head end is inserted in the restriction section to assemble the locating module on the deployed section of the first pin section. The locating module has a continuous section and an opening. The continuous section has a periphery. When the locating module is assembled with the deployed section of the first pin section, the periphery of the continuous section constantly interferes with the pivot pin (the second pin section or the chamber thereof). Accordingly, after the pivot pin or the second pin section is rotated, the locating module provides a locating effect for the pivot pin.

Alternatively, the deployed section of the first pin section has multiple column bodies. The column bodies together define a restriction section for holding or receiving the locating module. The restriction section has the form of a cavity. The column bodies are arranged at intervals, whereby each two adjacent column bodies define therebetween a slot.

The locating module has a cross-shaped configuration with a continuous section and an opening. The locating module is mounted in the restriction section and assembled with the deployed section of the first pin section. The continuous section of the locating module has at least one end section. When the locating module is assembled with the deployed section of the first pin section, the end section is positioned in the slot of the deployed section to constantly interfere with the second pin section or the chamber thereof. Accordingly, after the pivot pin or the second pin section is rotated, the locating module provides a locating effect for the pivot pin.

In the above locating module structure, the number of the locating modules mounted on the deployed section can be increased or decreased according to the actually needed elastic holding effect or frictional resistance.

The present invention can be best understood through the following description and accompanying drawings, wherein:

### BRIEF DESCRIPTION Of THE DRAWINGS

FIG. 1 is a perspective exploded view of a first embodiment of the locating module structure for pivot pin of the present invention, showing that the locating module includes multiple ring-shaped elastic members;

FIG. 2 is a perspective assembled view of the first embodiment of the locating module structure for pivot pin of the present invention, showing that the locating module is assembled with the pivot pin;

FIG. 3 is a sectional assembled view according to FIG. 2;

FIG. 4 is a perspective exploded view of a second embodiment of the locating module structure for pivot pin of the present invention, showing that the locating module includes multiple cross-shaped elastic members and the first pin section includes multiple column bodies;

FIG. 5 is a perspective assembled view of the second embodiment of the locating module structure for pivot pin of the present invention, showing that the locating module is assembled with the pivot pin; and

FIG. 6 is a sectional assembled view according to FIG. 4.

### DETAILED DESCRIPTION OF THE PREFERRED EMBODIMENTS

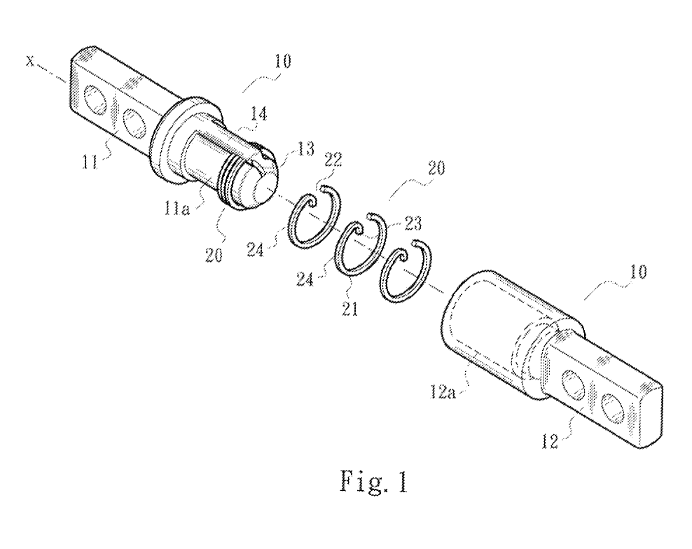

Please refer to FIGS. 1, 2 and 3. The locating module structure for pivot pin of the present invention includes a pivot pin 10 assembled with at least one locating module 20. The pivot pin 10 has an axis X and a deployed section 11. In this embodiment, the deployed section 11a has the form of a column body. The deployed section 11a means a position or an area where the pivot pin 10 is assembled with the locating module 20.

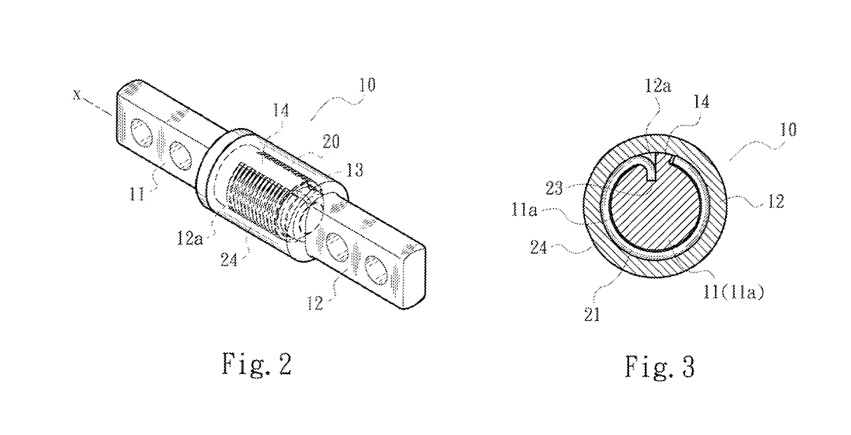

As shown in FIGS. 1 and 2, the pivot pin 10 includes a first pin section 11 and a second pin section 12, which can be fitted on the first pin section 11. The first and second pin sections 11, 12 are mounted or fixed between a main body and a movable body (such as a cover or display screen) of an electronic device (not shown). The deployed section 11a is positioned on the first pin section 11. The second pin section 12 has a chamber 12a corresponding to the deployed section 11a of the first pin section 11. The second pin section 12 or the chamber 12a is at least fitted on the deployed section 11a.

In a preferred embodiment, the deployed section 11a has a restriction section 13 for holding the locating module 20. The restriction section 13 is in the form of an insertion split extending along the axis X of the pivot pin 10 (or the first pin section 11). In this embodiment, the deployed section 11a is formed with a ridge-section 14 in adjacency to the restriction section 13. The ridge section 14 extends in the same direction as the restriction section 13. The locating module 20 is formed with a geometrical configuration corresponding to the first pin section 11 and the restriction section 13. To speak more specifically, the locating module 20 is a combination of multiple ring-shaped elastic members. Each locating module 20 has a continuous section 21 and an opening 22. The continuous section 21 has a head, end 23 at one end or a section in adjacency to the opening 22. The head end 23 is inserted in the restriction section 13 to assemble the locating module 20 on the deployed section 11a of the first pin section 11.

In principle, when the head end 23 of the locating module 20 is inserted into the restriction section 13, the ridge section 14 of the first pin section 11 or the deployed section 11a is positioned in the opening 22 of the locating module 20. In this embodiment, the continuous section 21 of the locating module 20 has a (outer) periphery 24. When the locating module 20 is assembled on the deployed section 11a of the first pin section 11, the outer periphery 24 constantly interferes with the second pin section 12 or chamber 12a of the pivot pin 10 as shown in FIGS. 2 and 3. Accordingly, after the first and second pin sections 11, 12 of the pivot pin 10 are relatively rotated, a locating effect is achieved.

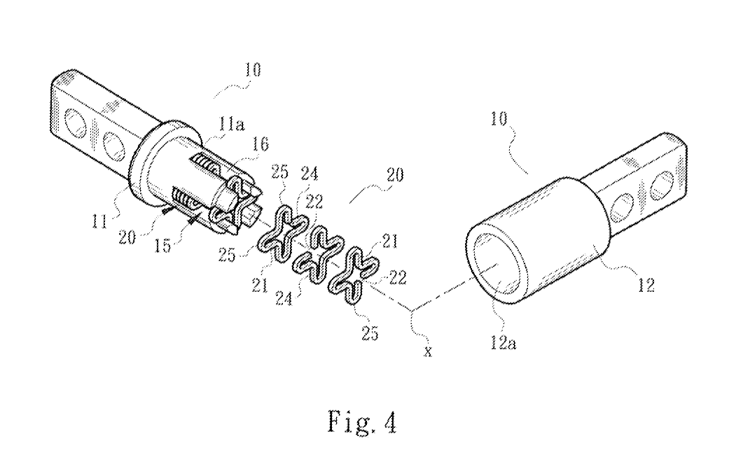

Please refer to FIGS. 4, 5 and 6, which show a second embodiment of the present invention. In this embodiment, the deployed section 11a of the first pin section 11 has multiple column bodies. The column bodies together define a restriction section 15 for holding or receiving the locating module 20. In this embodiment, the restriction section 15 has the form of a cavity. The column bodies are arranged at intervals, whereby each two adjacent column bodies define therebetween a gap or a slot 16.

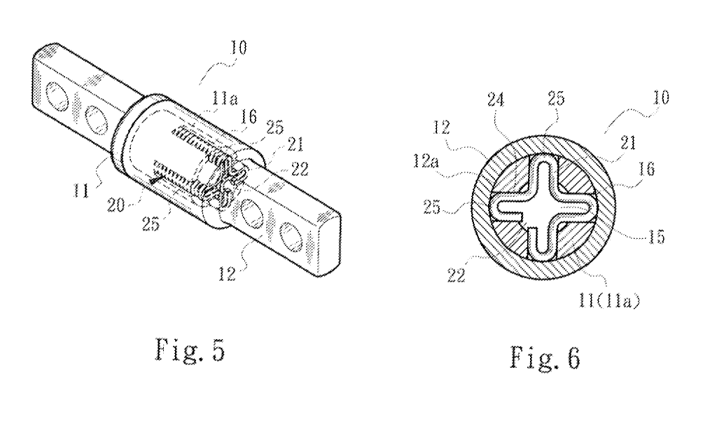

In a modified embodiment, the locating module 20 has a cross-shaped configuration with a continuous section 21 and an opening 22. The locating module 20 is mounted in the restriction section 15 and assembled with the deployed section 11a of the first pin section 10. The continuous section 21 (or the periphery 24) of the locating module 20 has at least one end section 25. When the locating module 20 is assembled with the deployed section 11a of the first pin section 11, the end section 20 is positioned in the slot 16 of the deployed section 11a to constantly interfere with the second pin section 12 or the chamber 12a as shown in FIGS. 5 and 6. FIG. 4 also shows that when the locating modules 20 are mounted in the deployed section 11a, the openings 22 of the locating modules 20 are positioned in different positions or directed in different directions. This helps in providing uniform action force when operating the first and second pin sections 11, 12 of the pivot pin 10 to rotate relative to each other.

It should be noted that the locating module 20 is a combination of multiple ring-shaped or cross-shaped elastic members. An assembler can increase or decrease the number of the elastic members of the locating module 20 according to the actually needed torque or frictional resistance between the first and second pin sections 11, 12 of the pivot pin 10. When the first and second pin sections 11, 12 are relatively rotated, the opening 22 of the locating module 20 provides larger allowable deformation or higher yield point for the locating module 20. That is, the locating module 20 is formed with the opening 22 to lower the internal stress of the locating module 20 when deformed. This can prolong the lifetime of the locating module 20 and the pivot pin 10.

In comparison with the conventional structure, the locating module structure for pivot pin of the present invention has the following advantages:

1. The pivot pin 10 and the locating module 20 are redesigned. The deployed section 11a of the pivot pin has a restriction section 13, 15 and the locating module 20 has a continuous section 21 and an opening 22. Such configuration is different from that of the conventional structure.

2. The locating module 20 can be easily manufactured in a modularized manner. The locating module 20 has an opening 22. Such configuration solves the problem existing in the conventional structure that the conventional structure is subject to deformation and damage under stress and the components of the conventional structure are easy to wear. Moreover, the locating module 20 can be more conveniently assembled with the pivot pin 10. For example, an assembler can increase or decrease the number of the elastic members of the locating module 20 according to the actually needed torque or frictional resistance between the first and second pin sections 11, 12 of the pivot pin 10. In addition, the opening 22 of the locating module 20 provides larger allowable deformation for the locating module 20.

3. In the conventional structure, the torque or frictional resistance is adjusted by means of adjusting the nut to tighten the gaskets to different extents. This often leads to deformation and damage of the gaskets. As a result, the pivot pin will be loosened and the operation will become unstable. Also, in use, the pivot pin will have non-uniform elastically holding effect or fractional resistance. This leads to a defective product and cause increase of manufacturing cost. In contrast, the locating module structure of the present invention is free from any of the above problems.

4. The locating module 20 is such configured that the locating module 20 has larger allowable deformation and higher yield point. Accordingly, the locating module 20 is applicable to different pivot pins with different specifications. Therefore, the application range of the locating module 20 is widened.

5. The locating module 20 is received in the chamber 12a of the second pin section 12. Therefore, the locating module 20 is protected from external unfavorable factors. Also, the appearance of the pivot pin 10 is kept tidy. In contrast, in the conventional structure, the elastic gaskets or locating components are exposed to outer side.

In conclusion, the locating module structure for pivot pin of the present invention has a configuration different from that of the conventional structure and is advantageous over the conventional structure.

The above embodiments are only used to illustrate the present invention, not intended to limit the scope thereof. Many modifications of the above embodiments can be made without departing from the spirit of the present invention.

What is claimed is:

1. A locating module structure for pivot pin, comprising at least one locating module, the locating module being formed with a geometrical configuration, the locating module having a continuous section and an opening, the continuous section having a periphery, which constantly interferes with the pivot pin.

2. The locating module structure for the pivot pin as claimed in claim 1, wherein the locating module is assembled with the pivot pin, the pivot pin having an axis and a deployed section, the locating module being mounted on the deployed section.

3. The locating module structure for the pivot pin as claimed in claim 2, wherein the pivot pin includes a first pin section and a second pin section, which can be fitted on the first pin section, the deployed section being positioned on the first pin section, the second pin section having a chamber corresponding to the deployed section of the first pin section, whereby the chamber of the second pin section is at least fitted on the deployed section.

4. The locating module structure for the pivot pin as claimed in claim 1, wherein the locating module has a cross-shaped configuration.

5. The locating module structure for the pivot pin as claimed in claim 2, wherein the deployed section has multiple column bodies, which together define a restriction section.

6. The locating module structure for the pivot pin as claimed in claim 5, wherein the restriction section has the form of a cavity and the column bodies are arranged at intervals, whereby each two adjacent column bodies define therebetween a slot.

7. The locating module structure for the pivot pin as claimed in claim 6, wherein the continuous section of the locating module has at least one end section, which is positioned in the slot of the deployed section.

8. The locating module structure for the pivot pin as claimed in claim 3, wherein the continuous section of the locating module has at least one end section, which constantly interferes with the chamber of the second pin section.

9. The locating module structure for the pivot pin as claimed in claim 2, wherein the locating modules are mounted on the deployed section with the openings of the locating modules directed in different directions.

10. The locating module structure for the pivot pin as claimed in claim 2, wherein the pivot pin is mounted between a main body and a movable body of an electronic device.
